(19) United States
(12) Patent Application Publication
(10) Pub. No.: US 2026/0334375 A1
(43) Pub. Date: Oct. 29, 2026

(54) PRUNING SHEARS WITH FLEXIBLE DRIVESHAFT

(71) Applicant: Milwaukee Electric Tool Corporation, Brookfield, WI (US)

(72) Inventors: Kevin S. Puls, Milwaukee, WI (US); Beth E. Cholst, Wauwatosa, WI (US); Mark J. Frykman, Mequon, WI (US)

(21) Appl. No.: 19/648,285

(22) Filed: Apr. 15, 2026

Related U.S. Application Data
(60) Provisional application No. 63/794,866, filed on Apr. 25, 2025.

(51) Int. Cl. A01G 3/08

(52) U.S. Cl. CPC A01G 3/085

(57) ABSTRACT

A pruning shear is provided. The pruning shear includes a housing including a motor, a pruning shear head extending between a first end and a second end opposite the first end, and a flexible driveshaft operably coupled between the motor of the housing and the pruning shear head. The pruning shear head includes a handle adjacent the first end, a first blade coupled to and extending from the handle towards the second end, and a second blade coupled to and extending from the handle towards the second end. The second blade is moveable relative to the first blade between an open position and a closed position.

### CROSS-REFERENCE TO RELATED APPLICATIONS

This application is a non-provisional application claiming the benefit of priority under 35 U.S.C. § 119(e) to U.S. Provisional Application No. 63/794,866, filed Apr. 25, 2025, which is hereby incorporated by reference in its entirety.

### FIELD

The present disclosure relates generally to working tools, and more particularly to pruning shears with flexible driveshafts.

### BACKGROUND

Various handheld and powered working tools may include an onboard battery and motor or an onboard motor and an offboard battery for transmitting power to the handheld working tool. Including an onboard motor and/or battery in a handheld working tool adds weight to the handheld tool, which can increase user fatigue during operation of the handheld working tool.

Accordingly, improved handheld working tools are desired in the art. In particular, handheld working tools, such as pruning shears, which reduce weight and user fatigue would be advantageous.

### BRIEF DESCRIPTION

Aspects and advantages of the present disclosure will be set forth in part in the following description, or may be obvious from the description, or may be learned through practice of the technology.

In accordance with one embodiment, a pruning shear is provided. The pruning shear includes a housing including a motor, a pruning shear head extending between a first end and a second end opposite the first end, and a flexible driveshaft operably coupled between the motor of the housing and the pruning shear head. The pruning shear head includes a handle adjacent the first end, a first blade coupled to and extending from the handle towards the second end, and a second blade coupled to and extending from the handle towards the second end. The second blade is moveable relative to the first blade between an open position and a closed position.

In accordance with another embodiment, a method of operating a pruning shear is provided. The method includes providing a housing including a motor, coupling a first end of a flexible driveshaft to the motor of the housing, and coupling a second end of the flexible driveshaft to a pruning shear head. The pruning shear head includes a handle adjacent the first end, a first blade coupled to and extending from the handle towards the second end, and a second blade coupled to and extending from the handle towards the second end. The method further includes activating the motor to reciprocate the first blade and the second blade between an open position and a closed position.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a pruning shear in accordance with embodiments of the present disclosure;

FIG. 2 is a perspective view of a housing of the pruning shear of FIG. 1 in accordance with embodiments of the present disclosure;

FIG. 3 is a perspective view of a pruning shear head of the pruning shear of FIG. 1 in accordance with embodiments of the present disclosure; and

FIG. 4 is a cross-sectional view of the pruning shear head of FIG. 3 in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “working tool” is intended to refer to a device which is used to perform a work operation, such as cutting materials like wood, metal, concrete, grass, or the like; trimming objects like branches; biasing fluids like air and water; and the like. By way of non-limiting example, working tools can include pruning shears, hedge trimmers, chainsaws, circular saws, reciprocating saws, grinders, string trimmers, lawnmowers, edgers, blowers, vacuums, snow throwers, mixers, augers, pumps, pipe threaders, drills, and impact wrenches. While embodiments provided below are directed to pruning shears, one or more components of the pruning shears described below, such as the flexible driveshaft, may be utilized with one or more different types of power tools.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

As used herein, the terms “actuate,” “movable,” and their variants are intended to refer to any physical manipulation of a component. Actuation or moving can include, for example, depressing, switching, or pushing a blade, hook, trigger, or button. Actuation or moving can also include, for example, reciprocating, rotating, or translating a working element such as one or more blades, saws, or bits.

In general, pruning shears disclosed herein include a pruning shear head having a cutting element, a housing including a motor and removeable power source, and flexible driveshaft coupled between the housing and the pruning shear head. The removable power source powers the motor, and the motor drives rotation of the flexible driveshaft. Rotary motion of the flexible driveshaft is converted to linear motion to actuate the cutting element of the pruning shear head. The housing including the motor and the removable battery are separate from the pruning shear head to reduce weight of the pruning shear head.

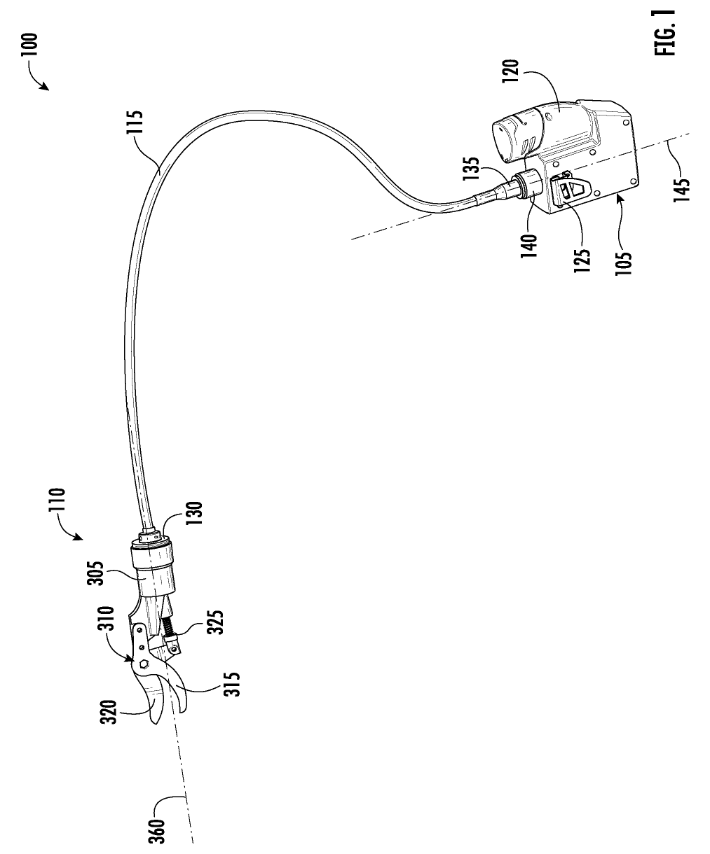

Referring now to the drawings, FIG. 1 illustrates a perspective view of a pruning shear 100 in accordance with embodiments of the present disclosure. The pruning shear 100 includes a housing 105, a pruning shear head 110, and a flexible driveshaft 115 operably coupled between the housing 105 and the pruning shear head 110. The housing 105 and the pruning shear head 110 are coupled to opposing ends of the flexible driveshaft 115. In at least one example embodiment, the flexible driveshaft 115 may include two or more modular driveshafts. The two or more modular driveshafts may be removably coupled to each other, the housing 105, and the pruning shear head 110 based on a desired length of the flexible driveshaft 115.

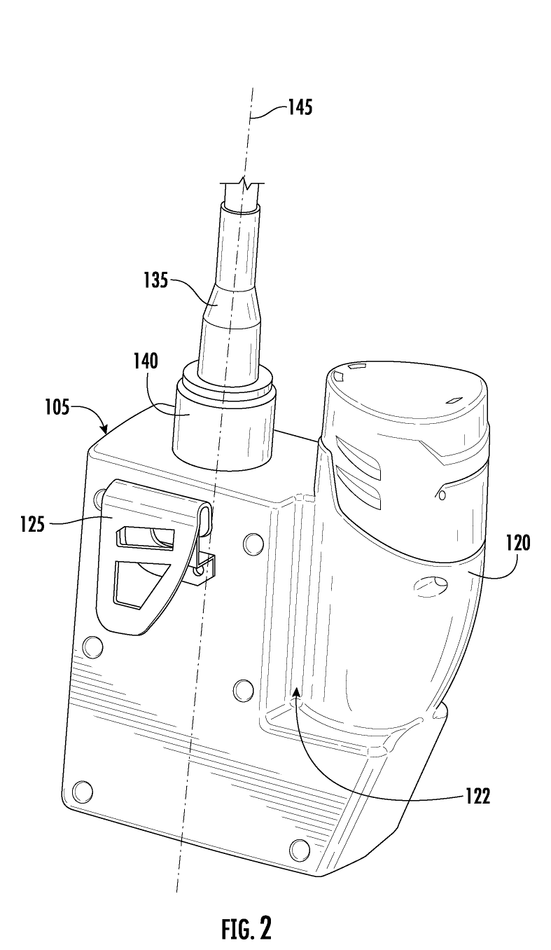

With reference to FIG. 2, illustrating a perspective view of the housing 105 of the pruning shear 100 of FIG. 1 in accordance with embodiments of the present disclosure, the housing 105 includes a motor (not shown) disposed within the housing 105 and a power source 120. As shown in FIG. 2, the housing 105 defines a battery receiving area 122 for removably receiving the power source 120. In at least one example embodiment, the power source 120 includes one or more removable batteries for supplying power to the motor.

The housing 105 includes a fastener 125 removably coupled to an exterior surface of the housing 105. The fastener 125 may be a clip for removably coupling the housing 105 to a user or operator of the pruning shear 100. For example, the fastener 125 may be removably coupled to an item, such as clothing, worn by the user or operator.

With reference to FIG. 1, the flexible driveshaft 115 includes a first connector 130 and a second connector 135 on opposing ends of the flexible driveshaft 115. The first connector 130 is removably couplable to the pruning shear head 110 and the second connector 135 is removably couplable to the housing 105. Additionally, the pruning shear head 110 may be interchanged or replaced with additional power tool attachments. For example, the additional power tool attachments may be removably coupled to the first connector 130. The additional power tool attachments include an end effector in some example embodiments.

Referring again to FIG. 2, the housing 104 includes a housing connector 140. The second connector 135 is removably coupled to the housing connector 140 for operably coupling the flexible driveshaft 115 to the motor disposed within the housing 104. In at least one example embodiment, the second connector 135 and the housing connector 140 include a plurality of threads such that the second connector 135 is removably secured to the housing connector 140 via a threaded engagement. For example, the second connector 135 is configured to rotate about a housing axis 145 extending through the housing connector 140 of the housing 105 for securing the second connector to and removing the second connector 135 from the housing connector 140. Moreover, the housing 105 may be interchanged or replaced with additional housing attachments. For example, the additional housing attachments may be removably couplable to the second connector 135.

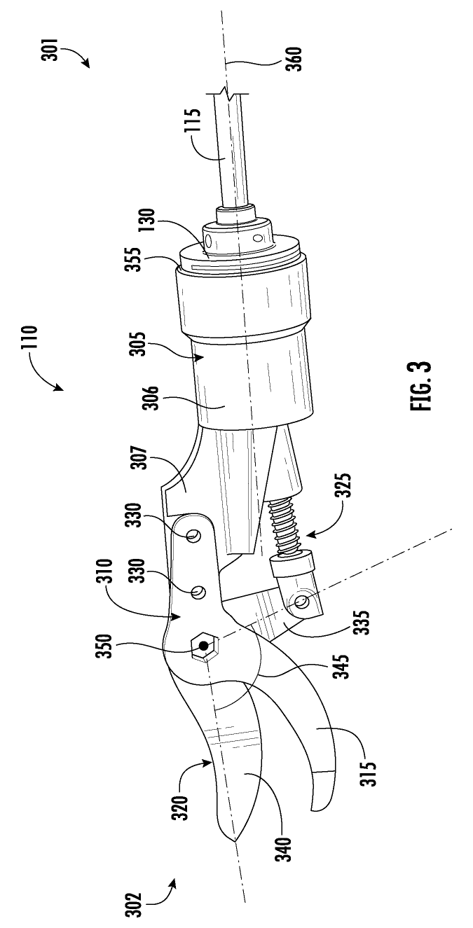

FIG. 3 illustrates a perspective view of the pruning shear head 110 of the pruning shear 100 of FIG. 1 in accordance with embodiments of the present disclosure. The pruning shear head 110 extends between a first end 301 and a second end 302 opposite the first end 301. As shown in FIGS. 1 and 3, the first end 301 of the pruning shear head 110 includes a handle 305, and a cutting element 310 extends from the handle 305 to the second end 302. More particularly, the handle 305 includes a base portion 306 adjacent the first end 301 and a support arm 307 extending from the base portion 306 towards the second end 302.

The cutting element 310 is coupled to the support arm 307 of the handle 305 and includes a first blade 315 and a second blade 320. More particularly, the first blade 315 is coupled to and extends from the support arm 307 of the handle 305. The first blade 315 is also fixedly coupled to the support arm 307 of the handle 305. For example, the first blade 315 may be fixedly coupled to at least a portion of the support arm 307 by one or more fasteners 330. The one or more fasteners 330 may include one or more screws, bolts, pins, or other suitable fasteners for securing the first blade 315 to the handle 305.

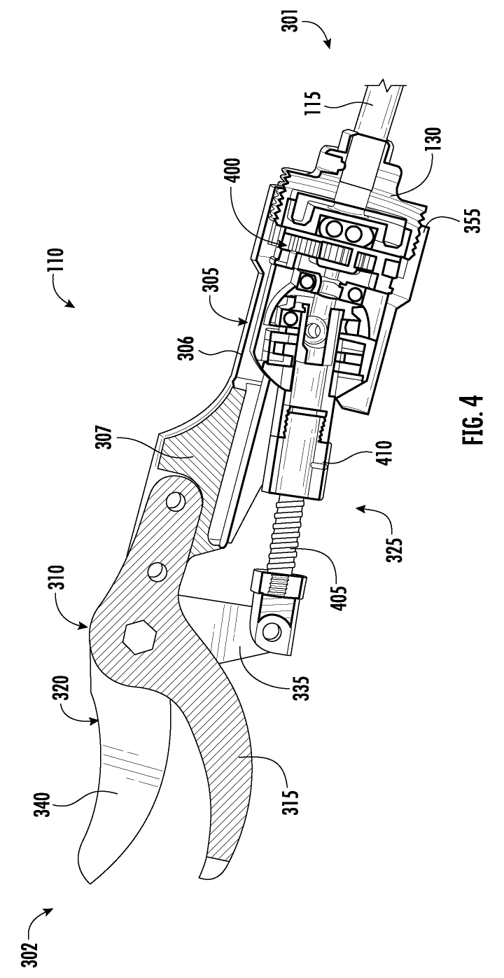

The second blade 320 is pivotably coupled to the first blade 315 and is coupled to the handle 305 via an actuator 325 extending from the handle 305 towards the second end 302, discussed below with respect to FIG. 4. For example, the actuator 325 extends from the base portion 306 of the handle 305 towards the second end 302. The second blade 320 includes a first blade portion 335 and a second blade portion 340 extending from the first blade portion 335. An end of the first blade portion 335 opposite the second blade portion 340 is coupled to the actuator 325. An angle 345 is defined between the first blade portion 335 and the second blade portion 340 relative to a pivot point 350 of the second blade 320. In at least one example embodiment, the angle 345 is greater than or equal to 90 degrees.

In at least one example embodiment, the second blade 320 is coupled to the first blade 315 at the pivot point 350. The second blade 320 is configured to pivot about the pivot point 350 relative to the first blade 315 between an open position and a closed position. For example, the second blade portion 340 of the second blade 320 moves towards the first blade 315 in the closed position and away from the first blade 315 in the second position. An object may be disposed between the first blade 315 and the second blade 320 in the open position. Subsequently, as the second blade 320 pivots or moves to the closed position, the object disposed therebetween can be cut.

The first blade 315 and the second blade portion 340 of the second blade 320 may have any suitable cutting configuration for cutting or pruning an object. For example, the first blade 315 and the second blade portion 340 of the second blade 320 may have a curved profile. More particularly, an inner surface of the first blade 315 may have a concave shape and inner surface of the second blade portion 340 of the second blade 320 may have a convex shape.

Still referring to FIG. 3, the base portion 306 of the handle 305 defines a cavity 355 adjacent the first end 301. The cavity is configured to removably receive the first connector 130 of the flexible driveshaft 115. The first connector 130 and the cavity 355 may include a plurality of threads for removably securing the flexible driveshaft 115 to the pruning shear head 110. For example, the pruning shear head 110 and/or the first connector 130 are rotatable about a pruning shear axis 360 extending through a center of the handle 305 for securing the first connector 130 to and removing the first connector 130 from the cavity 355 of the handle 305. Moreover, at least a portion of the pruning shear head 110 is rotatable about the pruning shear axis 360 for adjusting the position of the cutting element 310 relative to an object to be cut. For example, the cutting element 310 may be rotatable relative to the handle 305 or both the cutting element 310 and the handle 305 may be rotatable about the pruning shear axis 360 for adjusting a position of the cutting element 310 relative to the object to be cut.

FIG. 4 illustrates a cross-sectional view of the pruning shear head 110 of FIG. 3 in accordance with embodiments of the present disclosure.

As shown in FIG. 4, a geartrain 400 is disposed in the handle 305 of the pruning shear head 110 and operably coupled between the flexible driveshaft 115 and the actuator 325. For example, the geartrain is disposed in a portion of the cavity 355 of the base portion 306 of the handle 305. Rotary motion of the flexible driveshaft 115 is transferred to the geartrain 400. The actuator 325 translates the rotary motion of the geartrain 400 to linear motion for moving the first blade 315 and the second blade 320 between the open position and the closed position.

The actuator 325 includes a ball screw in some example embodiments. For example, the actuator 325 includes a shaft 405 and a nut housing 410. The shaft 405 is coupled between the geartrain 400 and an end of the first blade portion 335 of the second blade 320 opposite the second blade portion 340. The shaft 405 includes a plurality of threads such that rotation of the shaft 405 in a first rotational direction moves the shaft in a first linear direction towards the second end 302 of the pruning shear head 110 and rotation of the shaft 405 in a second rotational direction opposite the first rotational direction moves the shaft in a second linear direction towards the first end 301 of the pruning shear head 110. In such a manner, the second blade 320 is reciprocated between the open position and the closed position relative to the first blade 315.

Moreover, the nut housing 410 is coupled to the shaft 405. The nut housing 410 houses a plurality of balls (not shown) configured to roll within the plurality of threads of the shaft 405 within the nut housing 410. The plurality of balls reduce friction between the shaft 405 and the nut housing 410.

In at least one example embodiment, a method of operating the pruning shear 100 includes providing the housing 105 including the motor, coupling a first end of the flexible driveshaft 115 to the motor of the housing 105, and coupling a second end of the flexible driveshaft 115 to the pruning shear head 110. Coupling the first end of the flexible driveshaft 115 to the motor of the housing 105 includes coupling the second connector 134 to the housing connector 140. Coupling the second end of the flexible driveshaft 115 to the pruning shear head 110 includes coupling the first connector 130 to the cavity 355 of the handle 305 of the pruning shear head 110. As discussed above, the pruning shear head 110 extends between the first end 301 and the second end 302 and includes the handle 305 adjacent the first end 301, the first blade 315 coupled to and extending from the handle 305 towards the second end 302, and the second blade 320 coupled to and extending from the handle 305 towards the second end 302. The method additionally includes activating the motor of the housing 105 to reciprocate the first blade 315 and the second blade 320 between the open position and the closed position for cutting or pruning an object, such as limbs and branches of bushes, trees, or the like.

Further aspects of the disclosure are provided by one or more of the following embodiments:

A pruning shear, comprising: a housing including a motor; a pruning shear head extending between a first end and a second end opposite the first end, the pruning shear head comprising: a handle adjacent the first end, a first blade coupled to and extending from the handle towards the second end, and a second blade coupled to and extending from the handle towards the second end, wherein the second blade is moveable relative to the first blade between an open position and a closed position; and a flexible driveshaft operably coupled between the motor of the housing and the pruning shear head.

The pruning shear of any one or more of the embodiments, wherein the pruning shear head further comprises an actuator for moving the second blade between the open position and the closed position.

The pruning shear of any one or more of the embodiments, wherein: a geartrain is disposed in the handle of the pruning shear head and operably coupled to the flexible driveshaft; and rotary motion of the motor is transferred to the geartrain via the flexible driveshaft.

The pruning shear of any one or more of the embodiments, wherein the actuator comprises a ball screw coupled to the geartrain for converting rotary motion of the geartrain to linear motion for moving the second blade between the open position and the closed position.

The pruning shear of any one or more of the embodiments, wherein the second blade is pivotably coupled to the first blade.

The pruning shear of any one or more of the embodiments, wherein the first blade is fixedly coupled to the handle of the pruning shear head.

The pruning shear of any one or more of the embodiments, wherein opposing ends of the flexible driveshaft comprise a first connector and a second connector, and wherein the first connector is removably coupled to the handle of the pruning shear head and the second connector is removably coupled to the housing.

The pruning shear of any one or more of the embodiments, wherein the first connector and the second connector are threaded.

The pruning shear of any one or more of the embodiments, wherein: a pruning shear axis extends between the first end and the second end of the pruning shear head; the first end of the handle of the pruning shear head defines a cavity for receiving the first connector of the flexible driveshaft; and the pruning shear head is configured to rotate about the first connector and the pruning shear axis via the cavity for coupling the pruning shear head to the first connector and removing the pruning shear head from the first connector.

The pruning shear of any one or more of the embodiments, wherein: the housing comprising a housing connector; and the second connector of the flexible driveshaft is removably couplable to the housing connector for operably coupling the flexible driveshaft to the motor.

The pruning shear of any one or more of the embodiments, wherein the second connector is rotatable about a housing axis extending through the housing connector for coupling the flexible driveshaft to the housing connector and removing the flexible driveshaft from the housing connector.

The pruning shear of any one or more of the embodiments, wherein: a pruning shear axis extends between the first end and the second end of the pruning shear head; and at least a portion of the pruning shear head is configured to rotate about the pruning shear axis.

The pruning shear of any one or more of the embodiments, wherein the first blade and the second blade of the pruning shear head are rotatable about the pruning shear axis relative to the handle.

The pruning shear of any one or more of the embodiments, wherein the first blade, the second blade, and the handle of the pruning shear head is rotatable about the pruning shear axis.

The pruning shear of any one or more of the embodiments, wherein the housing is configured to receive a power source.

The pruning shear of any one or more of the embodiments, where the power source comprises one or more removable batteries.

The pruning shear of any one or more of the embodiments, wherein the flexible driveshaft comprises two or more modular driveshafts, and wherein the two or more modular driveshafts are removably couplable based on a desired length of the flexible driveshaft.

A method of operating a pruning shear, comprising: providing a housing including a motor; coupling a first end of a flexible driveshaft to the motor of the housing; coupling a second end of the flexible driveshaft to a pruning shear head, the pruning shear head comprising: a handle adjacent the first end, a first blade coupled to and extending from the handle towards the second end, and a second blade coupled to and extending from the handle towards the second end; and activating the motor to reciprocate the first blade and the second blade between an open position and a closed position.

The method of any one or more of the embodiments, wherein the flexible driveshaft comprises a first connector and a second connector at opposing ends of the flexible driveshaft.

The method of any one or more of the embodiments, wherein: coupling the first end of the flexible driveshaft to the motor of the housing comprises coupling the second connector to a housing connector of the housing; and coupling the second end of the flexible driveshaft to the pruning shear head comprises coupling the first connector to a cavity defined by the handle of the pruning shear head.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A pruning shear, comprising:
a housing including a motor;
a pruning shear head extending between a first end and a second end opposite the first end, the pruning shear head comprising:
a handle adjacent the first end,
a first blade coupled to and extending from the handle towards the second end, and
a second blade coupled to and extending from the handle towards the second end, wherein the second blade is moveable relative to the first blade between an open position and a closed position; and
a flexible driveshaft operably coupled between the motor of the housing and the pruning shear head.

2. The pruning shear of claim 1, wherein the pruning shear head further comprises an actuator for moving the second blade between the open position and the closed position.

3. The pruning shear of claim 2, wherein:
a geartrain is disposed in the handle of the pruning shear head and operably coupled to the flexible driveshaft; and
rotary motion of the motor is transferred to the geartrain via the flexible driveshaft.

4. The pruning shear of claim 3, wherein the actuator comprises a ball screw coupled to the geartrain for converting rotary motion of the geartrain to linear motion for moving the second blade between the open position and the closed position.

5. The pruning shear of claim 1, wherein the second blade is pivotably coupled to the first blade.

6. The pruning shear of claim 1, wherein the first blade is fixedly coupled to the handle of the pruning shear head.

7. The pruning shear of claim 1, wherein opposing ends of the flexible driveshaft comprise a first connector and a second connector, and wherein the first connector is removably coupled to the handle of the pruning shear head and the second connector is removably coupled to the housing.

8. The pruning shear of claim 7, wherein the first connector and the second connector are threaded.

9. The pruning shear of claim 7, wherein:
a pruning shear axis extends between the first end and the second end of the pruning shear head;
the first end of the handle of the pruning shear head defines a cavity for receiving the first connector of the flexible driveshaft; and
the pruning shear head is configured to rotate about the first connector and the pruning shear axis via the cavity for coupling the pruning shear head to the first connector and removing the pruning shear head from the first connector.

10. The pruning shear of claim 7, wherein:
the housing comprising a housing connector; and
the second connector of the flexible driveshaft is removably couplable to the housing connector for operably coupling the flexible driveshaft to the motor.

11. The pruning shear of claim 10, wherein the second connector is rotatable about a housing axis extending through the housing connector for coupling the flexible driveshaft to the housing connector and removing the flexible driveshaft from the housing connector.

12. The pruning shear of claim 1, wherein:
a pruning shear axis extends between the first end and the second end of the pruning shear head; and
at least a portion of the pruning shear head is configured to rotate about the pruning shear axis.

13. The pruning shear of claim 12, wherein the first blade and the second blade of the pruning shear head are rotatable about the pruning shear axis relative to the handle.

14. The pruning shear of claim 12, wherein the first blade, the second blade, and the handle of the pruning shear head is rotatable about the pruning shear axis.

15. The pruning shear of claim 1, wherein the housing is configured to receive a power source.

16. The pruning shear of claim 15, where the power source comprises one or more removable batteries.

17. The pruning shear of claim 1, wherein the flexible driveshaft comprises two or more modular driveshafts, and wherein the two or more modular driveshafts are removably couplable based on a desired length of the flexible driveshaft.

18. A method of operating a pruning shear, comprising:
providing a housing including a motor;
coupling a first end of a flexible driveshaft to the motor of the housing;
coupling a second end of the flexible driveshaft to a pruning shear head, the pruning shear head comprising:
a handle adjacent the first end,
a first blade coupled to and extending from the handle towards the second end, and
a second blade coupled to and extending from the handle towards the second end; and
activating the motor to reciprocate the first blade and the second blade between an open position and a closed position.

19. The method of claim 18, wherein the flexible driveshaft comprises a first connector and a second connector at opposing ends of the flexible driveshaft.

20. The method of claim 19, wherein:
coupling the first end of the flexible driveshaft to the motor of the housing comprises coupling the second connector to a housing connector of the housing; and
coupling the second end of the flexible driveshaft to the pruning shear head comprises coupling the first connector to a cavity defined by the handle of the pruning shear head.
